(19) United States
(12) Patent Application Publication
(10) Pub. No.: US 2009/0191358 A1
(43) Pub. Date: Jul. 30, 2009

(54) Method for Generation of Metal Surface Structures and Apparatus Therefor

(76) Inventors: Jolke Perelaer, Utrecht (NL); Berend Jan De Gans, Mülheim (DE); Ulrich S. Schubert, Eindhoven (NL)

Correspondence Address: FERRELLS, PLLC, P. O. BOX 312, CLIFTON, VA, 20124-1706, US

(21) Appl. No.: 11/992,259

(22) PCT Filed: Sep. 28, 2006
(86) PCT No.: PCT/EP2006/009437

§ 371 Date: Jan. 2, 2009

(51) Int. Cl. B05D 3/06

(52) U.S. Cl. 427/557

(57) ABSTRACT

Method for generation of metal surface structures and apparatus therefor Disclosed is a method for generating conductive surface patterns on a substrate by coating the substrate with metal particles and heating the coated substrate by means of microwave radiation. The process is easy to implement and can be used to generate metal pattern lit low cost.

This invention relates to the manufacture of surface metal patterns by a simple and efficient method and to an apparatus adapted to carry out this method.

Printing techniques, such as ink-jet printing, are interesting alternatives for the production of electronic and other structures. Printing has the advantage of low cost, ease of processing, potential for mass production and flexibility. A typical application is ink-jet printing of conductive tracks. Some different strategies were adopted to print such structures. In the scientific literature, the use of inks based on an (in)organic silver or copper precursor is described (A. L. Dearden et al. in Macromol. Rapid Commun. 2005, 26, 315-8 or Z. Liu et al. in Thin Solid Films 2005, 478, 275-9 or J. B. Szczech et al. in IEEE Trans. on Electronics Packaging Manuf., 2002, 25, 26-33 or C. M. Hong et al. in IEEE Electron Device Letters, 2000, 21, 384-6 or T. Cuk et al. in Appl. Phys. Lett. 2000, 77, 2063-5).

The precursor is reduced to metal via a post-printing thermal annealing step. In most cases, however, the ink used consists of a dispersion of noble metal nanoparticles, usually silver (S. Magdassi et al. in Mater. 2003, 15,2208, or A. Kamyshny et al. in Macromol. Rapid Commun., 2005, 26, 281-8), though the use of gold nonoparticles is also documented in the scientific literature (4) D. Huang et al. in Electrochem. Soc., 2003, 150, G412). The printed structures need a sintering step to become conductive. The use of nanoparticles reduces the sintering temperature due to the high surface-to-volume ratio, as disclosed in WO-A-2004/005,413.

In the past two different techniques were used to sinter printed nanoparticle structures, conventional radiation-conduction-convection heating being the most common method. To obtain sufficient conductivity temperatures required are typically above 200° C., whereas the sintering times are typically 60 minutes or more. The long sintering times required imply that the technique is not feasible for fast industrial production.

Examples for use of ink-jet printing for generating surface patterns are given in several patent documents.

WO-A-00/120,519 discloses preparations containing fine-particulate inorganic particles for ink-jet coating and for generating structured surfaces which are transformed via-sintering in reducing atmosphere into electrically conductive surfaces. No ink-jet printing of metallic particles and no microwave sintering of the generated surface patterns is described.

WO-A-97/138,810 discloses a method of manufacturing a sintered structure on a substrate by ink-jet printing of surface structure and sintering by laser. By repeating of this method a layer-by-layer structure is generated. Printing of metal nanoparticles and sintering by microwave radiation are not disclosed.

U.S. Pat. No. 6,508,550 and U.S. Pat. No. 6,425,663 describe microwave energy ink drying methods but no printing of metal nanoparticles or sintering by microwave radiation.

US-A-2003/10185971 discloses methods for ink-jet printing circuitry including different printing methods for pattern generation including use of metal nanoparticles to form a conductive path. Furthermore, different heating methods are disclosed but no heating by microwave radiation.

With heating methods disclosed in the prior art many potentially interesting materials, such as thermoplastic polymers or paper cannot be used as substrate, as these cannot withstand high temperatures (Kevin Cheng et al. in Macromol. Rapid Commun., 2005, 36, 247-64).

As an alternative a laser sintering method was developed (Nicole R. Bieri et al. in Superlattices and Microstructures 2004, 35, 437-44; or Tae Y. Clioi et al. in Appl. Phys. Lett. 2004, 85, 13-5; or Jaewon Chung et al. in Appl. Phys. Lett., 2004, 84, 801-3; or Nicole R. Bieri et al. in Appl. Phys. Lett., 2003, 82, 3529-31). The laser follows the conductive tracks and sinters these selectively, without affecting the substrate. This method however, is costly and complex from a technical point of view.

US-A-2005/136231 discloses the use of microwave radiation to shrink a shrinkable film. Different methods of heating a shrinkable polymer film are disclosed one thereof being microwave heating. While this document discloses the use of microwave radiation for shrinking a polymer film there is no disclosure about using microwave radiation for melting and/or sintering metal particles. The temperatures for shrinking given in the examples are far to low for effecting sintering and/or melting of the metal particles. There is no disclosure in this document to use microwave radiation to melt and/or to sinter the metal particles of the surface pattern to create a conductive pattern on said surface.

US-A-2004/209054 discloses the formation of embedded conductive traces in a thermoplastic substrate but the formation of conductive metal patterns on the surface of a substrate. Furthermore a conductive ink is already applied to the surface of a substrate. Thus this document does not disclose the formation of conductive metal patterns on the surface of a substrate and as a conductive ink is already applied to the surface of a substrate there is no need to create conductive patterns by melting and/or sintering of metal particles on the surface. In addition this document teaches only using microwave heating to evaporate the solvent of the ink but not the sintering/melting of metal particles to form a conductive pattern.

U.S. Pat. No. 4,585,699 discloses a method of applying microwave energy to heat treating coatings on dielectric supports. This document does not disclose to use microwave radiation to sinter and/or melt metal particles to form a conductive pattern.

Therefore in the prior art there is no disclosure about the use of microwave radiation to generate conductive metal patterns on a surface by causing metal particles applied to said surface to sinter and/or to melt.

Thus, it is an objective of the present invention to provide a fast, simple and thus cost-efficient technique that allows sintering or melting of printed structures by selective heating of the printed structure only.

Microwave heating of materials is fundamentally different from conventional radiation-conduction-convection heating.

The use of microwaves is restricted to materials that absorb microwave radiation, i.e. have a non-zero dielectric loss-factor e″ within the frequency range of interest.

Microwave sintering of metaloxydes, i.e. ceramics, was disclosed in a large number of patent documents. Microwave sintering of metals is generally considered as unfeasible, as metals strongly reflect rather adsorb microwaves. Nevertheless, microwave sintering of metals was disclosed in U.S. Pat. No. 6,183,689.

When using as substrate a material that absorbs microwaves to a lesser extent than the printed structure, i.e. a material with a lower dielectric loss-factor e″ within the range of frequencies used, the printed structure is sintered without affecting the substrate. Microwave radiation thus allows using substrate materials that are not thermally stable, i.e. would not be able to withstand the high temperatures required for conventional radiation-conduction-convection heating. The use of inkjet inks based on molecules bearing functional groups that polymerise under the influence of microwave radiation without thermally affecting the substrate was disclosed in US-A-2004/179,076. This patent document discloses novel microwave curable inks for ink-jet printing but neither discloses printing of metal nanoparticles nor their sintering by microwave radiation.

The present invention generally relates to a process for the fabrication of metallic structures or metallic patterns onto a substrate.

The present invention relates to a process for generating surface patterns on a substrate surface comprising the steps:
i) coating a surface of a substrate with a predetermined pattern of metal particles or of electrically conductive metal oxide particles by applying a dispersion containing said metal particles or said metal oxide particles in a liquid onto said surface,
ii) optionally drying said coated substrate to cause said liquid to evaporate,
iii) heating said substrate containing a pattern of said metal particles or of said metal oxide particles on said surface by means of microwave radiation to effect heating of said metal particles or of said metal oxide particles to melt and/or to sinter to form conductive metal patterns or conductive metal oxide patterns on said surface, and wherein
iv) said metal or said metal oxide and said substrate are selected such that the dielectric loss factor of the substrate is lower than 50% compared to the dielectric loss factor of the metal or of the metal oxide forming the surface pattern.

In the process of this invention generally each substrate can be used as long as this absorbs microwave radiation to a smaller extent as the metal particles applied to the surface of said substrate. The selection of substrate and metal is performed to result in a lower dielectric loss factor e″ of the material forming the substrate as compared to the dielectric loss factor e″ of the metal forming the surface pattern. In general the dielectric loss factor e″ of the substrate is lower than 50%, preferably lower than 10% of the dielectric loss factor e″ of the metal forming the surface pattern. This causes the microwaves to couple predominantly with the material with the highest dielectric loss factor, resulting in selective heating of the printed structure, which in turn results in an improvement of desirable properties, such as conductivity or mechanical strength.

More particularly, the substrate should absorb microwave radiation to a lesser extent than the metal that constitutes the printed structure, i.e. within the frequency range of interest the dielectric loss factor e″ of the metal that constitutes the printed structure should be considerably higher than the dielectric loss factor e″ of the substrate material.

A large variety of substrates can be chosen for the method of this invention. Non limiting examples are polymers (thermoplastic and duroplastic polymers including elastomers); inorganic materials, such as ceramic materials; semi-conducting substrates, such as silicon or gallium-arsenide, fibrous substrates containing natural and/or man-made fibers, such as paper, textile sheets including non-wovens; film and sheet materials made from polymers and or natural materials, such as leather, wood or thermoplastic sheet or bulk materials including composites containing said sheet or bulk materials.

Suitable substrates can possess a large variety of properties. For example, they can be transparent or non-transparent, or they can be crystalline or non-crystalline or they can contain adjuvants, such as pigments, antistatic agents, fillers, reinforcing materials, lubricants, processing aids and heat and/or light stabilizers.

Preferred substrates are thermoplastic polymers, such as polyesters (e.g. polyethyleneterephthalate), polyamides, polyimides, polyether-imides, polycarbonates, polyolefins (e.g. polyethylene or polypropylene), polyetherketones, polysiloxanes and polyarylenesulphides, such as polyphenylenesulphide.

As material forming the surface pattern in general each metal including metal alloys (hereinafter together called “metals”) or electrically conductive metal oxides can be chosen. Non limiting examples for metals are noble metals and metals of the platinum group. An example for an electrically conductive metal oxide is indium tin oxide. Preferably gold and especially preferred silver or silver alloys are used. Mixtures of different metals can also be used.

The metals or metal oxides are applied in the form of particles to the surface. The particle form helps to develop predetermined surface patterns. In addition it has been found that with smaller particle diameters and thus larger surface to volume ratios of the particles the heat generation and development of conductive patterns is promoted.

Typical mean particle diameters are in a range between 1 nm and 100 μm, preferably 1 nm-1 μm, very preferred 1 nm-100 nm and especially preferred 1 nm-50 nm. The mean particle diameter is determined by transmission electron microscope (TEM).

Very preferably metal or metal oxide nanoparticles are used, which allow the formation of conducting metal or metal oxide surface patterns with minimum amount of microwave energy.

The metal particles or metal oxide particles absorb microwave radiation, i.e. electromagnetic radiation with wavelengths ranging from 1 mm to 1 m in free space corresponding to a frequency between approximately 300 GHz to 300 MHz, respectively. It has been found that the use of microwave processing typically reduces heating time by a factor of 10 or more as compared to conventional heating methods.

The surface of the substrate is coated with the metal particles or the metal oxide particles by applying a dispersion containing said particles in a liquid onto said surface.

Different coating methods can be used as long as these allow the coating of a surface by creation of a predetermined surface pattern. Predetermined surface patterns can be layers covering the whole surface or other forms of surface coverage. Preferably surface patterns cover portions of the surface, for example in the form of tracks and/or of isolated spots of metal particles or metal oxide particles. Several surfaces of the substrate can be coated. For example two surfaces of a sheet material can be coated in the form of tracks which are optionally connected via holes going through the substrate and containing conductive material.

Examples of coating methods are known in the art of applying surface coatings, such as curtain coating, spin-coating or coating by means of doctor blade.

Preferably printing methods are used, such as offset printing or screen printing and very preferred ink-jet printing.

Initially, the coating material that forms the patterns on said surface(s) is present as a dispersion of metal particles or metal oxide particles in a carrier material that renders the coating material pasty or preferably fluid. The pasty coating material is hereafter referred to as “paste”. The fluid coating material is hereafter referred to as “ink”.

The paste of ink is applied to the surface of the substrate to form a pattern after drying by means of a printing technique, more particularly ink-jet printing.

When applying the paste or ink to the surface of the substrate the carrier material can be removed at the same time, for example by heating the substrate and by choosing a carrier material that evaporates or decomposes at the substrate temperature. In an alternative or an additional step the carrier material can be evaporated or decomposed after the formation of the surface pattern in a separate heat treatment step or the carrier material can be evaporated or decomposed during the treatment with microwave radiation.

After a predetermined pattern of metal particles or of metal oxide particles has been formed on the substrate surface(s) this is then exposed to microwave radiation.

As the microwaves couple predominantly with the metal particles or the metal oxide particles forming the material with the highest dielectric loss factor e″ this results in selective heating of the printed structure. Most of the heat generated by absorption of the microwave radiation develops in the metal particles or in the metal oxide particles and causes these to melt and/or to sinter, which in turn results in an improvement of desirable properties, such as conductivity or mechanical strength.

Preferably monomodal microwave radiation is used.

The equipment for performing the method of this invention can be chosen from known devices. Coating devices, heat treatment devices and microwave generators are known in the art and commercially available.

The processed substrates containing conductive surface patterns of metal can be compiled to form a layered product with several substrates possessing conductive patterns in the interior and on the surface. The layered products can contain layers of other materials besides the processed substrates containing conductive surface patterns of metal.

A typical device for performing the above-defined method comprises the combination of
A) a coating device for surface coating of a substrate with a predetermined pattern of metal particles or metal oxide particles, optionally
B) a heating device for heating the coated substrate, and
C) a microwave generator for treating the coated substrate to generate conductive patterns from the patterns of metal particles or of metal oxide particles on the surface of said substrate by melting and/or sintering said particles on said surface.

Preferably the coating device is an ink-jet printer.

Furthermore, the invention relates to the use of microwave radiation for the generation of conductive patterns by sintering and/or melting metal particles or metal oxide particles on a substrate surface.

The process for generating metallic surface patterns on a substrate surface can be used, for example, for the production of printed wiring boards or of integrated circuits, for the production of decorative sheets or for the production of of data recording or of data storing media, for the production of print boards, for the production of radio frequency identification devices (RFID devices) or for the production of electrical devices, like heating elements, resistors, coils or antennas.

These uses are also subject of the present invention.

The following Examples illustrate the invention without any limitation.

### EXAMPLE 1

### Printing and Sintering of Silver Tracks on Polyimide

A dispersion of silver nanoparticles in tetradecane known as Nanopaste™ was purchased from Harima Chemical Ltd. A polyimide foil with a thickness of 100 μm and known as Kapton HN was used as substrate.

A Microdrop Autodrop inkjet printer, equipped with a MD-K-140 dispenser system was filled with the aforementioned dispersion. An array of parallel lines with a typical length of 1 cm and a spacing of 5 mm in between was then printed onto the substrate by deposition of droplets with a spacing of 100 μm. To avoid bleeding of the ink the substrate was heated during printing at 100° C.

The polyimide foil with printed structure thereon was then treated during three minutes by microwave radiation using a monomode microwave oven operating at 2.45 GHz and a power of 300 W to cause sintering of the silver nanoparticles to form a conductive structure.

The resistance per unit distance of the sintered lines was 4-6Ω*cm⁻¹. The resistivity of the material as calculated from the resistance and the cross-sectional area of a line is 30*10⁻⁸Ω*m.

### EXAMPLES 2 AND 3

The procedure of Example 1 was repeated but using instead of a polyimide sheet a polyethylene terephthalate sheet (Example 2) or a polyether-imide sheet (Example 3).

The sample of Example 2 was treated for 480 seconds with 150 W microwave radiation to cause sintering of the silver nanoparticles to form a conductive structure.

The resistance per unit distance of the sintered lines was 5-7Ω*cm⁻¹. The resistivity of the material as calculated from the resistance and the cross-sectional area of a line was 30*10⁻⁸Ω*m.

The sample of Example 3 was treated for 270 seconds with 300 W microwave radiation to cause sintering of the silver nanoparticles to form a conductive structure.

The resistance per unit distance of the sintered lines was 8-12Ω*cm⁻¹.

1-18. (canceled)

19. A process for generating surface patterns on a substrate surface comprising the steps:
i) coating a surface of a substrate with a predetermined pattern of metal particles and/or of metal alloy particles by applying a dispersion containing said metal particles and/or said metal alloy particles in a liquid onto said surface,
ii) optionally drying said coated substrate to cause said liquid to evaporate,
iii) heating said substrate containing a pattern of said metal particles and/or said metal alloy particles on said surface by means of microwave radiation to effect heating of said metal particles and/or of said metal alloy particles to melt and/or to sinter to form conductive patterns on said surface, and wherein
iv) said metal and/or said metal alloy and said substrate are selected such that the dielectric loss factor of the substrate is lower than 50% compared to the dielectric loss factor of the metal and/or the metal alloy forming the surface pattern.

20. A process for generating surface patterns on a substrate surface comprising the steps:
i) coating a surface of a substrate with a predetermined pattern of electrically conductive metal oxide particles by applying a dispersion containing said metal oxide particles in a liquid onto said surface,
ii) optionally drying said coated substrate to cause said liquid to evaporate,
iii) heating said substrate containing a pattern of said metal oxide particles on said surface by means of microwave radiation to effect heating of said metal oxide particles to melt and/or to sinter to form conductive patterns on said surface, and wherein
v) said metal oxide and said substrate are selected such that the dielectric loss factor of the substrate is lower than 50% compared to the dielectric loss factor of the metal or the metal oxide forming the surface pattern.

21. A process as claimed in claim 19, wherein the substrate is selected from the group consisting of polymers, inorganic materials, semi-conducting substrates, fibrous substrates containing natural and/or man-made fibers, film and sheet materials made from polymers and/or natural materials.

22. A process as claimed in claim 19, wherein the substrate is a thermoplastic or duroplastic polymer, an elastomer, a ceramic material, silicon or gallium-arsenide, paper, leather, wood, thermoplastic sheet or bulk material or a composite containing said sheet or bulk material.

23. A process as claimed in claim 19, wherein the substrate is a thermoplastic polymer, preferably a polyester, a polyamide, a polyimide, a polyether-imide, a polycarbonate, a polyolefin, a polyetherketone, a polysiloxane and/or a polyarylenesulphide, very preferably a polyimide sheet, a polyester sheet or a polyether-imide sheet.

24. A process as claimed in claim 19, wherein the metal is gold and/or silver or where the metal alloy is silver alloy.

25. A process as claimed in claim 24, wherein the metal is silver.

26. A process as claimed in claim 19, wherein the particles possess a mean particle diameter between 1 nm and 100 μm, especially preferred between 1 nm and 50 nm.

27. A process as claimed in claim 19, wherein the predetermined surface pattern covers a portion of the surface in the form of tracks and/or of isolated spots of metal particles and/or of metal alloy particles.

28. A process as claimed in claim 27. wherein as a coating method a printing method is used.

29. A process as claimed in claim 28, wherein the printing method is ink-jet printing.

30. A process as claimed in claim 19, wherein the dispersion of metal particles and/or of metal alloy particles is in the form of a paste or preferably in the form of an ink.

31. A process as claimed in claim 19, wherein the substrate is heated during the coating of the surface with the dispersion of metal particles and/ or of metal alloy particles.

32. A process as claimed in claim 19, wherein microwave radiation used is a monomodal microwave radiation.

33. A process as claimed in claim 19, wherein said metal and/or said metal alloy and said substrate are selected that the dielectric loss factor of the substrate is lower than 10% compared to the dielectric loss factor of the metal and/or metal alloy forming the surface pattern.

34. Use of the process according to claim 19 for the production of printed wiring boards or of integrated circuits, for the production of decorative sheets, for the production of data recording or of data storing media, for the production of print boards, for the production of radio frequency identification devices (RFID devices) or for the production of electrical devices.

35. Use of the process according to claim 20 for the production of printed wiring boards or of integrated circuits, for the production of decorative sheets, for the production of data recording or of data storing media, for the production of print boards, for the production of radio frequency identification devices (RFID devices) or for the production of electrical devices.

36. Use according to claim 34, wherein the electrical device is a heating element, a resistor, a coil or an antenna.
